(19) United States
(12) Patent Application Publication
(10) Pub. No.: US 2016/0257088 A1
(43) Pub. Date: Sep. 8, 2016

(54) Can Crushing Apparatus

(71) Applicants: Judy Algea, Banning, CA (US); Robert Algea, Banning, CA (US)

(72) Inventors: Judy Algea, Banning, CA (US); Robert Algea, Banning, CA (US)

(21) Appl. No.: 15/060,823

(22) Filed: Mar. 4, 2016

Related U.S. Application Data
(60) Provisional application No. 62/127,900, filed on Mar. 4, 2015.

(51) Int. Cl. B30B 9/32; B30B 15/32; B30B 15/16; B30B 1/38

(52) U.S. Cl. CPC B30B 9/321; B30B 1/38; B30B 15/32; B30B 15/166

(57) ABSTRACT

A can crushing apparatus for crushing empty cans prior to recycling. The can crushing apparatus includes a base, a vertical support connected to the base, a piston housing connected to the vertical support, and an actuator disposed within the piston housing. A piston having a crush plate is disposed within the piston housing and is in operative communication with the actuator. A button in communication with a control circuit is disposed on the vertical support. When depressed, the button causes the control circuit to actuate the actuator, which causes the crush plate to extend downward. A can placed on the base is crushed by the crush plate and removed from the base via a jet of air from an opening in the vertical support.

### CROSS REFERENCE TO RELATED APPLICATIONS

This application claims the benefit of U.S. Provisional Application No. 62/127,900 filed on Mar. 4, 2015. The above identified patent application is herein incorporated by reference in its entirety to provide continuity of disclosure.

### BACKGROUND OF THE INVENTION

The present invention relates to devices for crushing cans. More specifically, the present invention relates to can crushing apparatuses having automatic push button operation and a can removal means.

Many individuals consume beverages from cans such as aluminum cans. Aluminum cans are recyclable, meaning discarded cans can be melted down and forged into new cans. Recycling aluminum cans alleviates landfill waste and provides a net benefit to the environment. However, one drawback to recycling aluminum cans is that the cans occupy significant amounts of space in a recycling container, which necessitates frequent removal and disposal. This may discourage individuals from recycling the aluminum cans, which are often left out on a countertop where they are an eyesore. Further, the aluminum cans that are not crushed may be more likely to become litter and harm the environment. Therefore, it is desirable to provide an apparatus configured for crushing cans to a smaller size so that a larger number of cans may be collected before disposal.

Devices and apparatuses for crushing cans are known in the prior art. Many prior art can crushing devices include a depressible lever for manually crushing a can. The lever must be depressed by an individual and often requires a considerable application of force before the can is crushed. It may be difficult for some individuals to apply the necessary amount of force to crush the can, which could discourage individuals from recycling the cans. Further, the crushed cans must be transported to a container for storage until they are taken to a recycling center. Transporting the crushed cans to a container can be an annoyance and may further discourage individuals from recycling. Other devices and apparatuses provide for automatic crushing of a can, but fail to provide a means for removing the can after it is crushed. It is therefore desirable to provide a can crushing apparatus that operates with the push of a button and automatically crushes a can, which can then be removed to a recycling container via compressed air.

### SUMMARY OF THE INVENTION

In view of the foregoing disadvantages inherent in the known types of can crushing devices and apparatuses now present in the prior art, the present invention provides a can crushing apparatus wherein the same can be utilized for providing convenience for the user when crushing and disposing of cans. The present system comprises a base having an upper surface configured to support a can thereon. A vertical support having an upper end and a lower end is connected to the base at the lower end and extends vertically from the base. A piston housing having an interior volume, an upper portion, and a lower portion is connected to the vertical support, and the lower portion of the piston housing is positioned over the base. An actuator is disposed within the interior volume of the piston housing at the upper portion of the piston housing. A piston having a distal end and a proximate end is disposed within the interior volume of the piston housing. The piston is in operative communication with the actuator and connected thereto at the proximate end of the piston. Further, a crush plate is connected to the distal end of the piston. A control circuit for providing electric power to the can crushing apparatus is operatively connected to a button disposed on an exterior surface of the can crushing apparatus. The button is configured to actuate the actuator, and the crush plate is configured to contact an upper surface of can supported on the base, whereby the crush plate is lowered and crushes the can upon actuation of the actuator.

One object of the present invention is to provide a can crushing apparatus having all the advantages of prior art can crushing devices and apparatuses but none of the disadvantages.

Another object of the present invention is to provide a can crushing apparatus that is operable via a push button disposed on an exterior surface of the can crushing apparatus.

A further object of the present invention is to provide a can crushing apparatus that can be supported on a horizontal surface or mounted to a wall.

Yet another object of the present invention is to provide a can crushing apparatus having a weight sensor for detecting the weight of an object, where the weight sensor is connected to the control circuit and prevents the crush plate from crushing unwanted objects.

Still a further object of the present invention is to provide a can crushing apparatus having a control circuit configured to extend the crush plate to a working position upon depression of a push button in operative communication with the control circuit.

Still another object of the present invention is to provide a can crushing apparatus having a control circuit configured to return the crush plate to a starting position upon release of the push button in operative communication with the control circuit.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of a can crushing apparatus according to the present invention with the crush plate in a raised position.

FIG. 1B shows a perspective view of a can crushing apparatus according to the present invention with the crush plate in a working position.

FIG. 2 shows a side view of a can crushing apparatus according to the present invention.

FIG. 3 shows a schematic view of the electronic components of a can crushing apparatus according to the present invention.

### DETAILED DESCRIPTION OF THE INVENTION

Reference is made herein to the attached drawings. Like reference numerals are used throughout the drawings to depict like or similar elements of the can crushing apparatus. For the purposes of presenting a brief and clear description of the present invention, the preferred embodiment will be discussed as used for crushing aluminum drinking cans. The figures are intended for representative purposes only and should not be considered to be limiting in any respect.

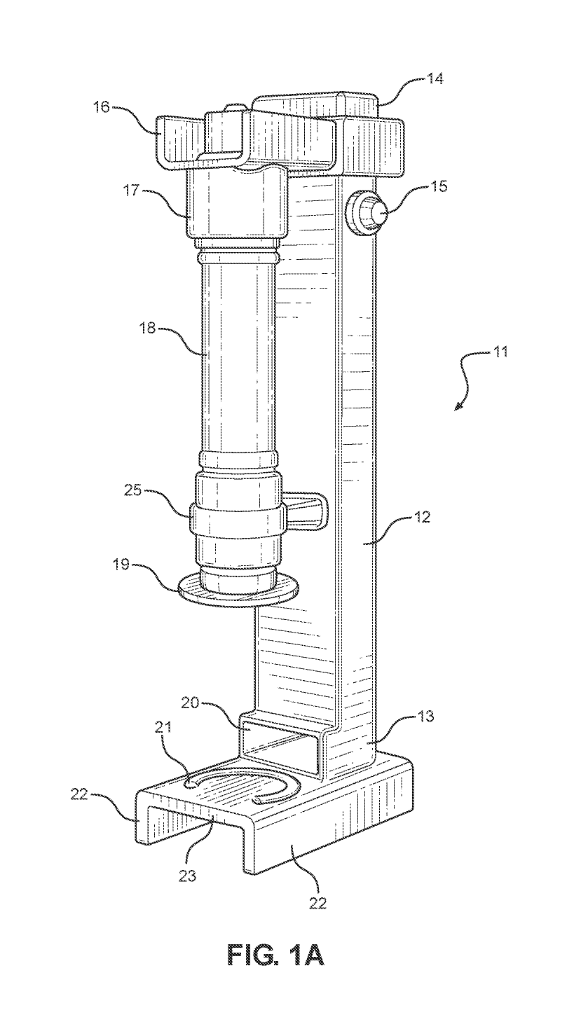

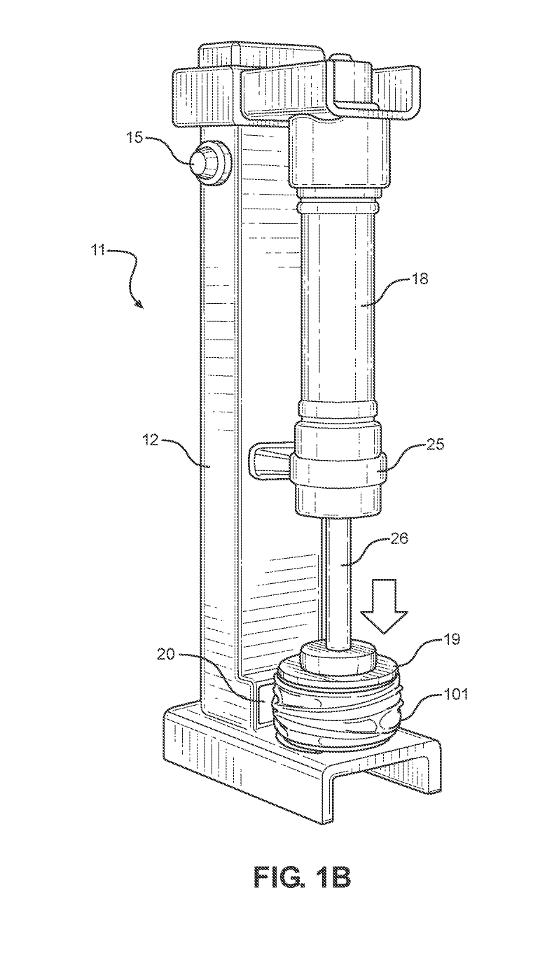

Referring now to FIG. 1, there is shown a perspective view of a can crushing apparatus according to the present invention with the crush plate in a raised position is shown. The can crushing apparatus 11 generally comprises a base 23 having an upper surface 21. The upper surface 21 of the base 23 is configured to support a can thereon, and may further comprise a projection such as a rim disposed thereon for retaining the can in place during crushing. In one embodiment, the base 23 comprises support legs 22 that are disposed on opposing sides of a lower surface of the base 23. The support legs 22 support the can crushing apparatus 11 on a flat surface.

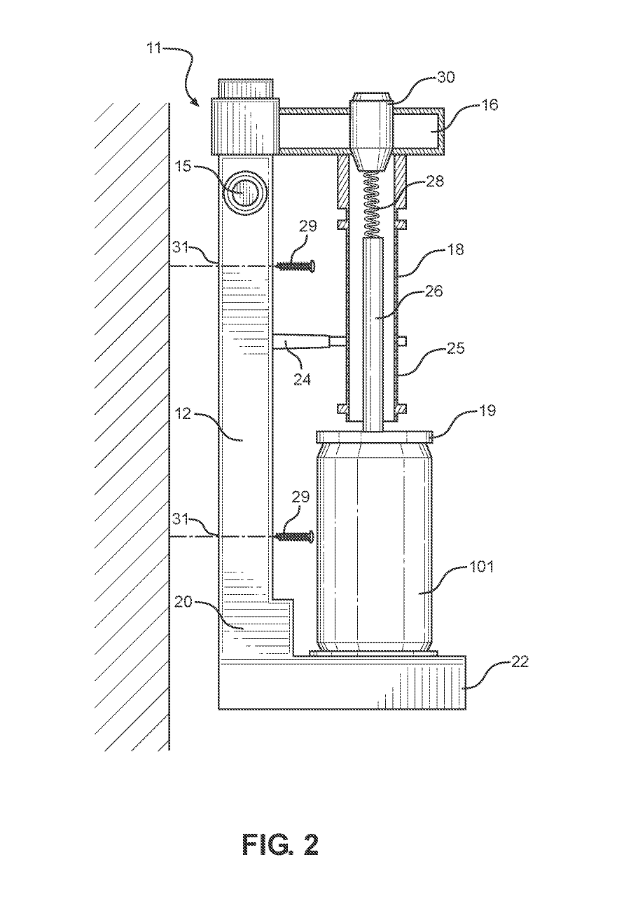

A vertical support 12 having a lower end 13 and an upper end 14 extends vertically from the upper surface 21 of the base 23. A piston housing 18 having an upper portion 17 and a lower portion 25 is connected to the vertical support. In one embodiment of the invention, the piston housing 18 is connected to the vertical support 12 via an upper connector 16, which is in turn connected to the upper end 14 of the vertical support 12. A crush plate 19 contacts the lower portion 25 of the piston housing 18 and is connected to a piston disposed within the piston housing 18, which is shown in FIG. 2. A button 15 is disposed on an outer surface of the vertical support 12. When depressed, the button 15 causes the crush plate 19 to descend from a raised position to a working position.

An opening 20 is disposed on the lower end 13 of the vertical support 12. Upon crushing a can with the crush plate 19, a jet of air is expelled from the opening 20 in order to cause the crushed can to fall into a receptacle where it may remain until it is removed for recycling. The jet of air is supplied by an air compressor that may be disposed within an interior volume of the vertical support in one embodiment. In an alternative embodiment, the air compressor is an external air compressor in operative communication with the opening 20 via an air hose or similar connector.

Referring now to FIG. 1B, a perspective view of a can crushing apparatus according to the present invention with the crush plate in a working position is shown. A can 101 is shown crushed by the can crushing apparatus 11. When a user depresses the button 15 disposed on the vertical support 12, the piston 26 moves downward out of the piston housing 18, and the crush plate 19 contacts the can 101 and causes it to crush to a smaller shape. In this crushed shape, the can 101 takes up less space in a recycling container. The crushed can 101 is then removed via the jet of air from the opening 20 on the vertical support 12. A recycling bin may be placed beneath the can crushing apparatus 11, so that the removed can 101 may fall directly into the bin.

Referring now to FIG. 2, a side view of a can crushing apparatus according to the present invention is shown. In this view, the piston housing 18 is transparent so as to see the components disposed therein. The can crushing apparatus 11 further comprises an actuator 30 disposed within the interior volume of the piston housing 12. The actuator 30 is in operative communication with the piston 26. In the illustrated embodiment, the actuator 30 is a spring actuator having a bias spring 28. Other embodiments may use other types of actuators, such as linear actuators, hydraulic actuators, pneumatic actuators, and the like. The actuator 30 forces the piston 27 downward and out of the lower end 25 of the piston housing 18 when the button 15 is depressed.

In addition to being supported on the ground, the can crushing apparatus 11 may also be mounted to a wall. In one embodiment, the vertical support 12 further comprises mounting apertures 31 disposed thereon. The mounting apertures 31 are configured to receive fasteners 29 therethrough. The fasteners 29 secure the can crushing apparatus to a wall, whereby a rear surface of the vertical support 12 contacts the wall surface. Any suitable fastener 29 may be used, such as screws, nails, or the like. Further, the piston housing 18 is further secured to the vertical support 12 via a lower support 24, which provides additional structural support to the can crushing apparatus 11, particularly when mounted on a wall.

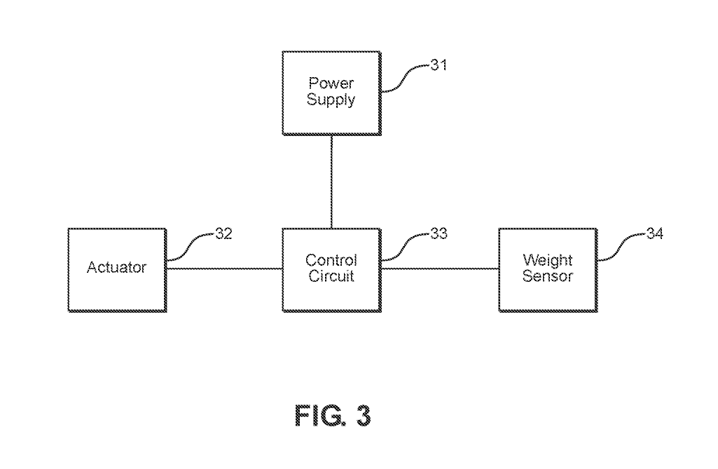

Referring now to FIG. 3, a schematic view of the electronic components of a can crushing apparatus according to the present invention is shown. The can crushing apparatus comprises a control circuit 33 in operative communication with a power supply 31, which supplies power to each of the electronic components of the can crushing apparatus. The power supply may be a standard wall outlet or may be a battery disposed within the can crushing apparatus. The control circuit is further in operative communication with the button disposed on the can crushing apparatus and is configured to extend the crush plate when the button is depressed.

Other embodiments of the can crushing apparatus may further include various safety mechanisms to protect users of the can crushing apparatus and other articles from being accidentally crushed. In an example embodiment, the control circuit 33 is configured to actuate the actuator 30 and lower the crush plate when the button is depressed, and is further configured such that releasing the button causes the control circuit 33 to reverse the actuator 32 and automatically raise the crush plate. In this embodiment, a user must keep constant pressure on the button to depress the crush plate, and a lack of pressure causes the crush plate to automatically raise. In this way, the can crushing apparatus is provided with an additional safety feature, because an individual can simply release the button if an unwanted object is in the path of the crush plate.

In another alternate embodiment, the can crushing apparatus further comprises a weight sensor 34 disposed on the base that is in operative communication with the control circuit 33. The control circuit 33 further comprises a safety switch which is configured to prevent the actuator 32 from extending the crush plate unless the weight sensor registers a value within a threshold range. For example, an empty aluminum can weighs 15 grams on average. As such, the weight sensor 34 may be configured to allow actuation of the actuator 32 only if the weight registered by the sensor is between 14 and 16 grams. Other threshold values may be utilized according to user preference. The safety switch prevents hands or other unwanted objects from being accidentally crushed by the crush plate.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A can crushing apparatus comprising:
a base having an upper surface configured to support a can thereon;
a vertical support having an upper end and a lower end connected to the base at the lower end and extending vertically from the base;
a piston housing having an interior volume, an upper portion, and a lower portion connected to the vertical support, wherein the lower portion of the piston housing is positioned over the base;
an actuator disposed within the interior volume of the piston housing at the upper portion of the piston housing;
a piston disposed within the interior volume of the piston housing, the piston having a distal end and a proximate end, wherein the piston is in operative communication with the actuator and connected thereto at the proximate end;
a crush plate connected to the distal end of the piston;
a control circuit for providing electric power to the can crushing apparatus, the control circuit being operatively connected to a button disposed on an exterior surface of the can crushing apparatus;
whereby the button is configured to actuate the actuator; and
whereby the crush plate is configured to contact an upper surface of a can supported by the base.

2) The can crushing apparatus of claim 1, wherein the piston housing is connected to the vertical support via a lower connector disposed on the lower end of the piston housing and an upper connector disposed on the upper end of the piston housing.

3) The can crushing apparatus of claim 1, further comprising:
a weight sensor disposed on the upper surface of the base, wherein the weight sensor is in operative communication with the control circuit.

4) The can crushing apparatus of claim 3, where the control circuit further comprises a safety switch configured to prevent actuation of the actuator unless the weight sensor registers a weight within a threshold range.

5) The can crushing apparatus of claim 1, wherein the vertical support has an opening disposed on the lower end thereof, wherein the opening is in communication with an air compressor.

6) The can crushing apparatus of claim 1, wherein the control circuit is configured to release air from the air compressor when the push button is released.

7) The can crushing apparatus of claim 1, wherein the control circuit is configured to extend the crush plate to a working position upon depression of the push button.

8) The can crushing apparatus of claim 1, wherein the control circuit is configured to return the crush plate to a starting position upon release of the push button.

9) The can crushing apparatus of claim 1, wherein the vertical support further comprises a rear surface having mounting apertures disposed thereon, wherein the mounting apertures are each configured to accept a fastener therethrough for mounting the can crushing apparatus to a wall.

10) The can crushing apparatus of claim 1, wherein the base further comprises a lower surface having support legs extending downward therefrom, wherein the support legs are disposed on opposing sides of the lower surface of the base, and wherein the support legs support the can crushing apparatus on a horizontal surface.

11) The can crushing apparatus of claim 1, wherein the actuator is a linear actuator.

12) The can crushing apparatus of claim 1, wherein the actuator is a pneumatic actuator.

13) The can crushing apparatus of claim 1, wherein the actuator is hydraulic actuator.

14) The can crushing apparatus of claim 1, wherein the vertical support further comprises opposing side surfaces, and wherein the push button is disposed on either one of the opposing side surfaces.
